(19) United States
(12) Patent Application Publication
(10) Pub. No.: US 2007/0038439 A1
(43) Pub. Date: Feb. 15, 2007

(54) Audio signal generation

(75) Inventors: Erik Gosuinus Petrus Schuijers, Eindhoven (NL); Marc Willem Theodorus Klein Middelink, Eindhoven (NL); Leon Maria Van De Kerkhof, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V. GROENEWOUDSEWEG 1, 5621 BA EINDHOVEN (NL)

(21) Appl. No.: 10/552,773

(22) PCT Filed: Apr. 14, 2004
(86) PCT No.: PCT/IB04/50432

§ 371 Date: Oct. 12, 2005

(30) Foreign Application Priority Data
Apr. 17, 2003 (EP) 03076134.0
Apr. 29, 2003 (EP) 03076280.1

(51) Int. Cl. G10L 21/00

(52) U.S. Cl. 704/212; 704/501

(57) ABSTRACT

An output audio signal (L, R) is generated based on an input audio signal, the input audio signal comprising a plurality of input subband signals (N). The input subband signals are delayed in a plurality of delay units (76) to obtain a plurality of delayed subband signals, wherein at least one input subband signal is delayed more than a further input subband signal of higher frequency, and wherein the output audio signal is derived (77) from a combination of the input audio signal and the plurality of delayed subband signals.

The invention relates to generating an output audio signal based on an input audio signal, and in particular to an apparatus for supplying an output audio signal.

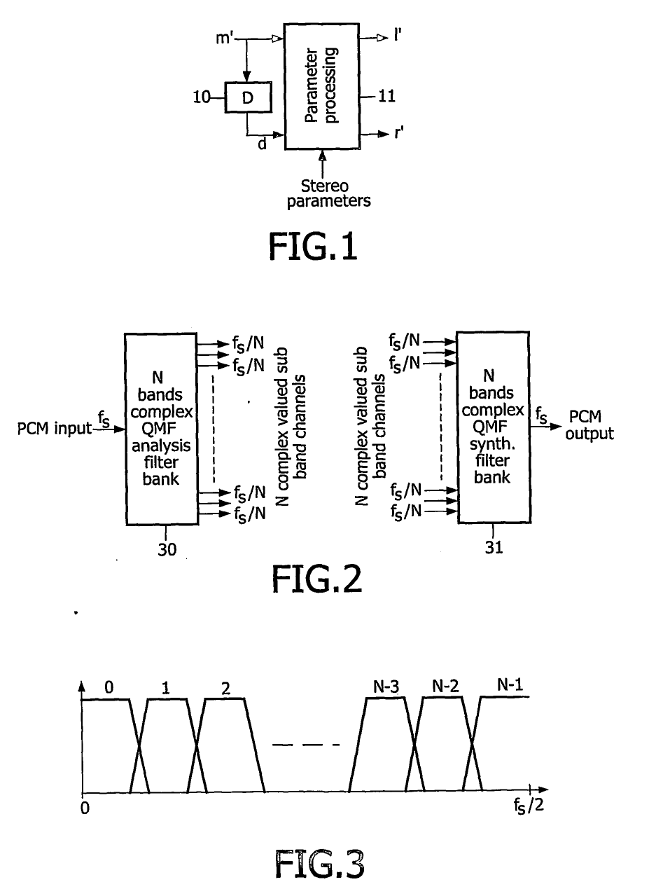

Erik Schuijers, Werner Oomen, Bert den Brinker and Jeroen Breebaart, “Advances in Parametric Coding for High-Quality Audio”, Preprint 5852, 114th AES Convention, Amsterdam, The Netherlands, 22-25 Mar. 2003 disclose a parametric coding scheme using an efficient parametric representation for the stereo image. Two input signals are merged into one mono audio signal. Perceptually relevant spatial cues are explicitly modeled. The merged signal is encoded using a mono parametric encoder. The stereo parameters Interchannel Intensity Difference (IID), the Interchannel Time Difference (ITD) and the Interchannel Cross-Correlation (ICC) are quantized, encoded and multiplexed into a bitstream together with the quantized and encoded mono audio signal. At the decoder side the bitstream is de-multiplexed to an encoded mono signal and the stereo parameters. The encoded mono audio signal is decoded in order to obtain a decoded mono audio signal m′ (see FIG. 1). From the mono time domain signal, a de-correlated signal is calculated using a filter D 10 yielding optimum perceptual de-correlation. Both the mono time domain signal m′ and the de-correlated signal d are transformed to the frequency domain. Then the frequency domain stereo signal is processed with the IID, ITD and ICC parameters by scaling, phase modifications and mixing, respectively, in a parameter processing unit 11 in order to obtain the decoded stereo pair l′ and r′. The resulting frequency domain representations are transformed back into the time domain.

In the MPEG-4 (ISO/IEC 14496-3:2002) Proposed Draft Amendment (PDAM) 2, Section 5.4.6, such a de-correlated signal is obtained by convoluting/filtering the mono-signal with a pre-defined impulse response.

Non pre-published European patent application 02077863.5 (Attorney docket PHNL020639) describes the use of an all-pass filter, e.g. a comb filter, comprising a frequency dependent delay to derive such a de-correlated signal. At high frequencies, a relatively small delay is used, resulting in a coarse frequency resolution. At low frequencies, a large delay results in a dense spacing of the comb filter. The filtering may be combined with a band-limiting filter, thereby applying the de-correlation to one or more frequency bands.

An object of the invention is to advantageously generate an output audio signal on the basis of an input audio signal. To this end, the invention provides a device, a method and an apparatus as defined in the independent claims. Advantageous embodiments are defined in the dependent claims.

According to a first aspect of the invention, an output audio signal is generated based on an input audio signal, the input audio signal comprising a plurality of input subband signals, wherein at least part of the input subband signals is delayed to obtain a plurality of delayed subband signals, wherein at least one input subband signal is delayed more than a further input subband signal of higher frequency, and wherein the output audio signal is derived from a combination of the input audio signal and the plurality of delayed subband signals. By providing such a frequency dependent delay in the subband domain, parametric stereo can advantageously be implemented especially in those audio decoders where the core decoder already includes a subband filter bank. Filter banks are commonly used in the context of audio coding, e.g. MPEG-1/2 Layer I, II and III all make use of a 32 bands critically sampled subband filter. The plurality of delayed subband signals may be used as a subband domain equivalent of the de-correlated signal as described above. In ideal circumstances the correlation between the plurality of delayed subband signals and the input audio signal is zero. However, in practical embodiments, the correlation may be up to 40% for acceptable audio quality, up to 10% for medium to high quality audio and up to a 2 or 3% for high audio quality.

In an embodiment of the invention the output audio signal includes a plurality of output subband signals. Combining the delayed subband signals and the input subband signals in subband domain in order to obtain the plurality of output subband signals is then relatively easy to implement. In practical embodiments, a time domain output audio signal is synthesized from the plurality of output subband signals in a synthesis subband filter bank.

In order to obtain an efficient implementation a plurality of delay units is provided, wherein the number of delay units is smaller than the number of input subband signals, and wherein the input subband signals are subdivided in groups over the plurality of delays.

Best audio quality is obtained in embodiments where the delays in the plurality of delay units are monotonically increasing from high frequency to low frequency.

In an advantageous embodiment of the invention, a complex filter bank is used, which is effectively oversampled by a factor of two because for every real input sample a complex output sample is generated which consists of effectively two values: a real and a complex one. This eliminates the large aliasing components of which the MPEG-1 and MPEG-2 critically sampled filter bank suffers.

In an efficient embodiment of generating the output audio signal, a Quadrature Mirror Filter (“QMF”) bank is used. Such a filter bank is known per se from Per Ekstrand, “Bandwidth extension of audio signals by spectral band replication”, Proc. 1st IEEE Benelux Workshop on Model based Processing and Coding of Audio (MPCA-2002), pp. 53-58, Leuven, Belgium, Nov. 15, 2002. FIG. 2 shows a block diagram of such a complex QMF analysis and synthesis filter bank. The analysis bank 30 divides the signal into N complex valued sub bands, which are down sampled internally by a factor of N. A stylized frequency response is shown in FIG. 3. The synthesis QMF filter bank 31 takes the N complex sub band signals as input and generates a real valued PCM output signal. According to an insight of the inventors, when a complex QMF filter bank is used, a de-correlated signal can be created which is perceptually very close to the ‘ideal’ situation. For such a complex QMF filter bank, implementations exist which are more efficient than the convolution used in MPEG-4 PDAM 2, Section 5.4.6; such a convolution is relatively expensive with respect to computational load and memory usage. As an additional advantage, using a complex QMF filter bank also allows for an efficient combination of parametric stereo and Spectral Band Replication (“SBR”). The idea behind SBR is that the higher frequencies can be reconstructed from the lower frequencies using only very little helper information. In practice, this reconstruction is done by means of a complex Quadrature Mirror Filter (QMF) bank. In order to efficiently come to a de-correlated signal in the subband domain, embodiments of the invention use a frequency (or subband index) dependent delay in the subband domain. Because the complex QMF filter bank is not critically sampled no extra provisions need to be taken in order to account for aliasing. Furthermore, as the delay is small, the over-all RAM usage of this embodiment is low. Note that in the SBR decoder as disclosed by Ekstrand, the analysis QMF bank consists of only 32 bands, while the synthesis QMF bank consists of 64 bands, as the core decoder runs at half the sampling frequency compared to the entire audio decoder. In the corresponding encoder however, a 64 bands analysis QMF bank is used to cover the whole frequency range.

The use of an integer number of subband samples delayed signal as de-correlated signal causes time-domain smearing, i.e. the signal placement in time is not preserved. This may cause artefacts around transients, i.e. in those cases where a signal strength change is above a predetermined threshold. Signal strength can be measured in amplitude, power, etc. In an advantageous embodiment of the invention, artefacts around transients are mitigated by deriving a de-correlated signal in the surroundings of a transient by using fractional delays instead of integer delays. A fractional delay is a delay less than the time between two subsequent subband samples and can easily be implemented by using a phase rotation. A transition from fractional delays to the integer delays, and vice-versa, may result in discontinuities in the de-correlated signal. In order to prevent such discontinuities, an advantageous embodiment of the invention provides a cross-fade to go back from using the fractionally delayed decorrelated signal to the integer delayed decorrelated signal.

These and other aspects of the invention are apparent from and will be elucidated with reference to the embodiments described hereinafter.

In the drawings:

FIG. 1 shows a block diagram of parametric stereo decoder;

FIG. 2 shows a block diagram of an N bands complex QMF analysis (left) and synthesis (right) filter bank;

FIG. 3 shows a stylized frequency response of the N bands QMF filter banks of FIG. 2;

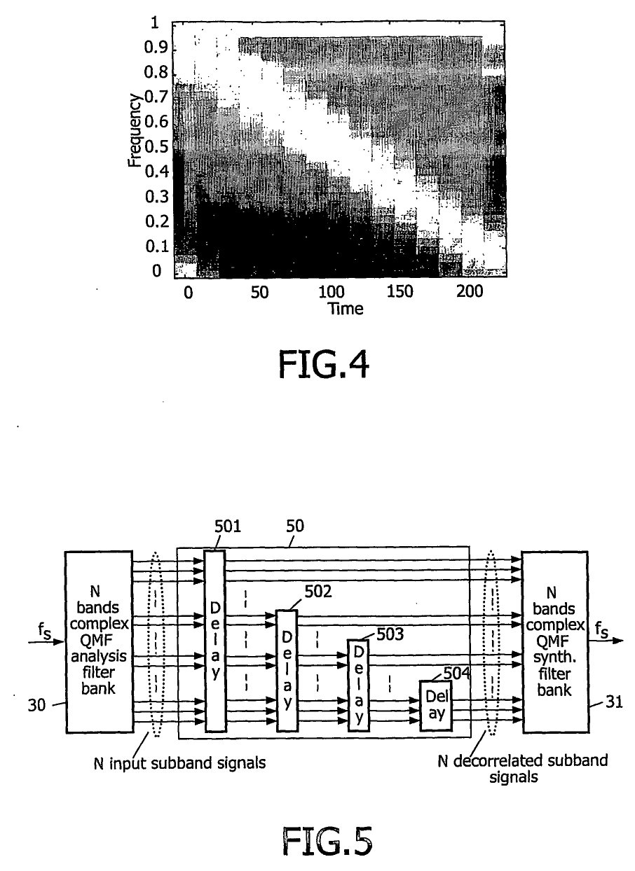

FIG. 4 shows a spectrogram of an impulse response used in MPEG-4 PDAM 2, Section 5.4.6 to generate the de-correlated signal, wherein the x-axis denotes time (samples) and the y-axis denotes the normalized frequency;

FIG. 5 shows a block diagram showing a device according to an embodiment of the invention;

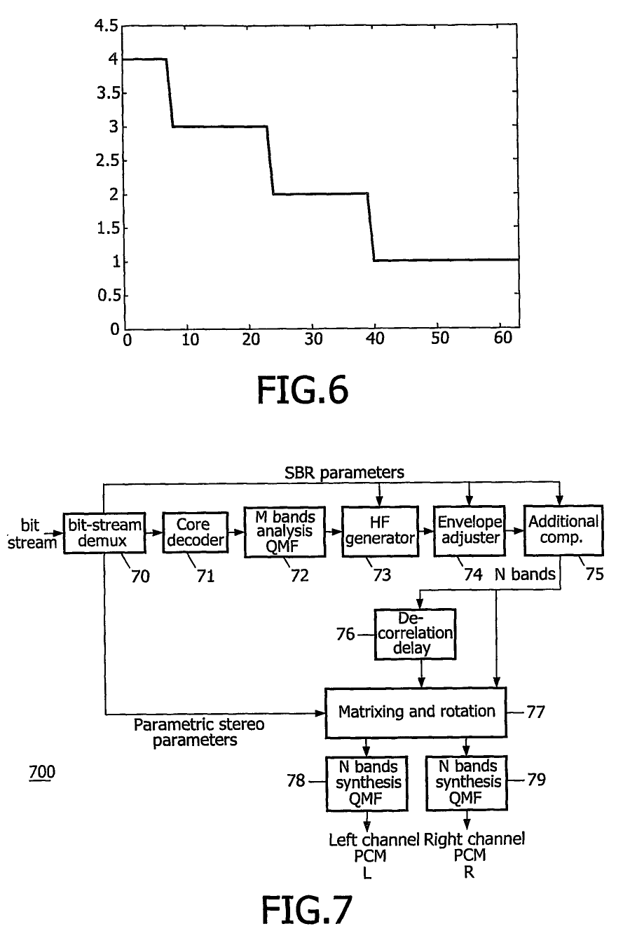

FIG. 6 shows a delay expressed in subband samples as a function of subband index according to an embodiment of the invention;

FIG. 7 shows an advantageous audio decoder according to an embodiment of the invention, which combines parametric stereo with spectral band replication, and

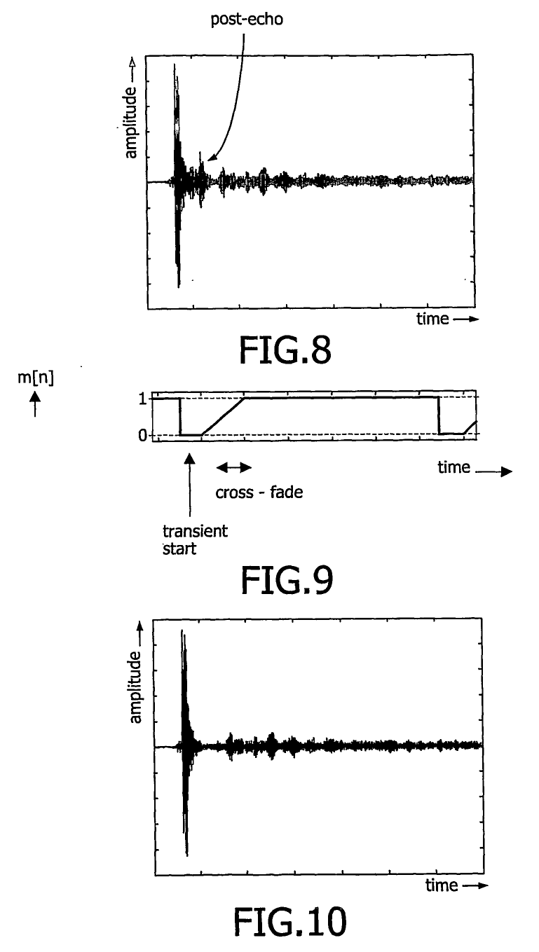

FIG. 8 shows the occurrence of a post-echo after a transient, caused by mixing with an integer delayed decorrelated signal;

FIG. 9 shows an example of mixing coefficients, a value of 1 denoting that an integer delayed decorrelated signal is used, and a value of 0 denoting that a fractionally delayed decorrelated signal is used;

FIG. 10 shows a resulting output audio signal when using the mixing factor of FIG. 9, and

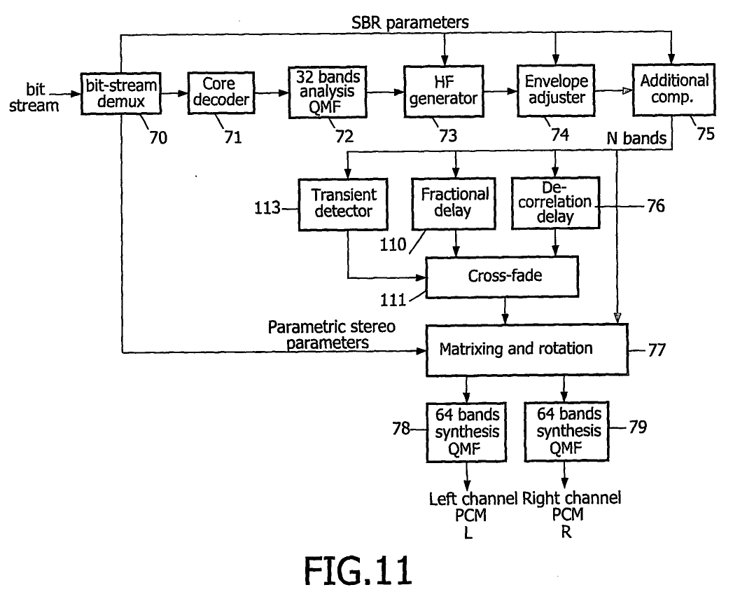

FIG. 11 shows the audio decoder of FIG. 7, wherein a further delay unit having fractional delays is used.

The drawings only show those elements that are necessary to understand the invention.

In the following, an advantageous embodiment of the invention is described for generating a stereo output audio signal based on a mono input audio signal by using parametric stereo. The input audio signal includes a plurality of input subband signals. The plurality of input subband signals are delayed in a plurality of delay units providing more delay for lower frequency subbands than for higher frequency subbands. The delayed subband signals serve as a subband domain version of the de-correlated signal needed in the generation of the stereo output signal.

In MPEG-4 PDAM 2, Section 5.4.6, the de-correlated signal is obtained by first calculating a phase characteristic φ, which for a sampling frequency fₛ of 44.1 kHz equals:

$$φ = \frac{π k ( k - 1 )}{K} + {φ}_{0} \qquad ( 1 )$$

where φ₀ has a value of π/2, K is equal to 256 and k=0 . . . 256. From this phase response function a filter impulse response is then calculated using the inverse FFT. It resembles a linear delay. This delay can be approximated by:

$$d = K - \frac{K}{π} f \qquad ( 2 )$$

where d is the delay in samples and the frequency in radians.

Preferably, the input subband signals are obtained in a complex QMF analysis filter bank, which may be present in a remote encoder, but which may also be present in the decoder. As the outputs of a complex QMF filter bank are down sampled by a factor of N it is not possible to exactly map a desired time domain delay to a delay within each sub band. A perceptually good approximation can be obtained by using rounded versions of the delay function (2) as described above. As an example, the delay within each subband for N=64 subbands is shown in FIG. 6. For this particular implementation only 136 complex values have to be stored in order to form the de-correlated signal. Note that for the higher frequencies still a delay of a single sub-band sample is employed, although the delay function above describes a value of 0 at half the sampling frequency. The delay of a single sub-band sample ensures that the signal is maximally de-correlated.

FIG. 5 shows a block diagram of a device 50 according to an embodiment of the invention for generating the plurality of delayed subband signals. The device 50 is placed somewhere between the QMF analysis filter bank 30 and the QMF synthesis filter bank 31 and comprises a plurality of delay units 501, 502, 503 and 504. The delay unit 501 provides a one unit delay for all subbands. A group of higher frequency subbands, e.g. bands 40-64, is furnished without further delay to the synthesis QMF filter bank 31. The group of relatively low frequency subbands, e.g. bands 0-40, is further delayed in delay unit 502. Part of this group, e.g. bands 0-24, is further delayed in delay unit 503 and delay unit 504 (the latter for subbands 0-8 only). So effectively an exemplary amount of 4 groups of different delay are created, having delays of 1, 2, 3 or 4 unit delays respectively. The delay expressed in subband samples as a function of subband index is shown in FIG. 6. The QMF analysis filter bank 30 is usually present in an audio encoder, although for SBR a smaller M bands analysis QMF filter bank is also used in the decoder.

FIG. 7 shows an advantageous audio decoder 700 according to an embodiment of the invention which combines a parametric stereo tool and SBR. A bit-stream demux 70 receives the encoded audio bitstream and derives the SBR parameters, the stereo parameters and the core encoded audio signal. The core encoded audio signal is decoded using a core decoder 71, which can e.g. be a standard MPEG-1 Layer III (mp3) or an AAC decoder. Typically such a decoder runs at half the output sampling frequency (fₛ/2). The resulting core decoded audio signal is fed to an M subbands complex QMF filter bank 72. This filter bank 72 outputs M complex samples per M real input samples and is thus effectively over-sampled by a factor of 2, as explained before. In a High-Frequency (HF) generator 73, higher frequency subbands N-M, which are not covered by the core decoded audio signal, are generated by replicating (certain parts of) the M subbands. The output of the high-frequency generator 73 is combined with the lower M subbands into N complex sub-band signals. Subsequently an envelope adjuster 74 adjusts the replicated high frequency sub-band signals to the desired envelope and an additional component adding unit 75 adds additional sinusoidal and noise components as indicated by the SBR parameters. The total N subband signals are furnished to a delays unit 76, which may be equal to the device 50 shown in FIG. 5, in order to generate the delayed subband signals. The N delayed subband signals and the N input subband signals are processed in combining unit 77 in dependence on stereo parameters such as the ICC parameter so as to derive N output subband signals for a first output channel and N output subband signals for a second output channel. The N output subband signals for the first output channel are fed through the N bands complex QMF synthesis filter 78 to form the first PCM output signals for left L. The N output subband signals for the second output channel are fed through the N bands complex QMF synthesis filter 79 to form the first PCM output signals for right R. In practical embodiments, N=64 and M=32.

The approach presented above is well suited for stationary signals. However, for non-stationary, i.e. transient-like signals problems occur using this approach. This is illustrated in FIG. 8 which shows the result of one channel of a castanets signal as obtained using the integer delayed decorrelated signal of FIGS. 5 and 6 as basis for deriving the output audio signal. Typically, in a signal with strong transients, e.g. castanets, the correlation between the left and right channel just after a transient is relatively low, as the signal is mainly consisting of reverberation. The de-correlated signal is thus mixed in quite prominently. This results in a clear post-echo just after the actual castanets transient. Although, due to post-masking in the time-domain, this is not perceived as a second transient, it still causes an undesired colouration of the sound. In an advantageous embodiment of the invention, this artefact is mitigated by forming the de-correlated signal in the surroundings of a transient by using a fractional delay. Such a fractional delay can be implemented efficiently using phase rotations. In a further embodiment, in order to prevent discontinuities in the overall de-correlated signal, the fractionally delayed decorrelated or phase-rotated signal is (slowly) cross-faded over time with the integer delayed de-correlated signal.

Hence, it is proposed to use a fractionally delayed or phase rotated version of the original signal instead of the frequency-dependent integer delay, starting from the transient position. Because of the temporal post-masking properties of the human auditory system it is not very critical how this de-correlated signal must be calculated. As such, the decorrelated signal can e.g. be obtained by applying a 90 degrees phase shift in each sub-band of the original signal.

In order to prevent discontinuities in the de-correlated signal from the transient on, a cross-fade is preferably applied between the integer delayed and the phase rotated signal. This cross-fade can be performed as:
d_{hybrid}[n]=m[n]d_{delay}[n]+(1−m[n])dᵣₒₜₐₜᵢₒₙ[n]
where n is a (sub-band) sample index, m[n] is a mixing or cross-fade factor, d_{delay}[n] is the de-correlated (sub-band) signal formed by the frequency-dependent integer delay, dᵣₒₜₐₜᵢₒₙ[n] is the de-correlated sub-band signal formed by the fractional delay or phase rotation and d_{hybrid}[n] is a resulting hybrid de-correlated signal. The mixing factor m[n] becomes zero at the start of the transient. It then remains zero for a period of time typically corresponding to around 20 ms (approx. 12 ms for the length of the delay and 8 ms for the length of the transient). The fade-in from zero to one is typically around 10-20 ms. The mixing factor m[n] can, but is not restricted to be linear or piece-wise linear. Note that this mixing factor m[n] can also be frequency dependent. As the delay is typically shorter for the higher frequencies, it is perceptually preferable to have a shorter cross-fades for the higher frequencies than for the lower frequencies.

FIG. 11 shows the audio decoder of FIG. 7, wherein a fractional delay unit 110 having fractional delays is used to derive fractionally delayed subband signals. The delays unit 76 produces frequency-dependent delayed subband signals. In practice, the fractional delay unit 110 may operate in parallel to the delays unit 76, although it is also possible to switch off the further delay unit 110 when the delays unit 76 is running and vice versa. Preferably, switching is performed between the fractionally delayed subband signals and the frequency-dependent delayed subband signals in a switching unit 111. The switching unit 111 preferably performs a cross-fade operation as explained above, although hard switching is also possible. The cross-fade operation is dependent on the detection of transients. The detection of transients is preferably performed in transient detector 113. Alternatively, it is possible in an encoder to include a switching indicator in the encoded audio bitstream. Then the bitstream demultiplexer 70 derives the switching indicator from the bit-stream and furnishes this switching indicator to the switching unit 111, wherein the switching is then performed in dependence on the switching indicator.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word ‘comprising’ does not exclude the presence of other elements or steps than those listed in a claim. The invention can be implemented by means of hardware comprising several distinct elements, and by means of a suitably programmed computer. In a device claim enumerating several means, several of these means can be embodied by one and the same item of hardware. The mere fact that certain measures are recited in mutually different dependent claims does not indicate that a combination of these measures cannot be used to advantage.

1. A device for generating an output audio signal (L, R) based on an input audio signal, the input audio signal comprising a plurality of input subband signals (N), the device comprising:
a plurality of delay units (76, 501 . . . 504) for delaying at least part of the input subband signals to obtain a plurality of delayed subband signals, wherein at least one input subband signal is delayed more than a further input subband signal of higher frequency, and
a combining unit (77) for deriving the output audio signal from a combination of the input audio signal and the plurality of delayed subband signals.

2. A device as claimed in claim 1, wherein the output audio signal includes a plurality of output subband signals.

3. A device as claimed in claim 2, the device further comprising a subband filter bank (78, 79) for synthesizing a time domain output audio signal (L,R) from the plurality of output subband signals.

4. A device as claimed in claim 1, wherein the input audio signal is a mono audio signal and the output audio signal is a stereo audio signal.

5. A device as claimed in claim 1, wherein the number of delay units is smaller than the number of input subband signals, and wherein the input subband signals are subdivided in groups over the plurality of delays units.

6. A device as claimed in claim 5, wherein the plurality of delay units comprises a first delay unit (501) for delaying a group of relatively high frequency subbands with one subband sample, and at least one further delay unit (502 . . . 504) for delaying a group of relatively low frequency subbands with at least a further subband sample.

7. A device as claimed in claim 1, wherein the delay units provide delays which are monotonically increasing from high frequency to low frequency.

8. A device as claimed in claim 1, wherein the subband filter bank is a complex subband filter bank.

9. A device as claimed in claim 8, wherein the complex subband filter bank is a complex Quadrature Mirror Filter bank.

10. A device as claimed in claim 1, the device further comprising:
an input (70) for obtaining a correlation parameter indicative of a desired correlation between a first channel (L) and a second channel (R) of the output audio signal (L,R), and
wherein the combining unit (77) is arranged for obtaining the first channel (L) and the second channel (R) by combining the input audio signal and the plurality of delayed subband signals in dependence on the correlation parameter.

11. A device as claimed in claim 10, wherein the first channel (L) and the second channel (R) each comprise a plurality of output subband signals, and wherein the device further comprises two synthesis subband filter banks (78,79) coupled to an output of the combining unit (77) for generating a first time domain channel (L) and a second time domain channel (R) on the basis of the output subband signals respectively.

12. A device (700) as claimed in claim 1, wherein the device (700) further comprises:
an analysis filter bank (72) of M subbands to generate M filtered subband signals on the basis of a time domain core audio signal,
a high frequency generator (73, 74) for generating a high frequency signal component derived from the M filtered subband signals, the high frequency signal component having N-M subband signals, where N>M, the N-M subband signals including subband signals with a higher frequency than any of the subbands in the M subbands, the M filtered subbands and the N-M subbands together forming the plurality of input subband signals (N).

13. A device as claimed in claim 1, wherein the plurality of delay units is arranged for delaying the at least part of the input subband signals with a delay of an integer number of subband samples, wherein at least one input subband signal is delayed more than a further input subband signal of higher frequency, and wherein the device further comprises:
a fractional delay unit for delaying the at least part of the input subband signals with a delay which is a fraction of a time between two subsequent subband samples and which delay may be constant for all of the at least part of the input subband signals, and
a switching unit for switching between the plurality of delay units and the fractional delay unit in order to obtain the plurality of delayed subband signals.

14. A device as claimed in claim 13, wherein the switching unit switches by cross-fading between the output of the plurality of delays and the output of the fractional delay.

15. A device as claimed in claim 13, wherein the device further comprises a detection unit for detecting a signal strength of the input audio signal, and wherein the switching means is arranged for switching to the fractional delay in the case that the signal strength is above a predetermined threshold, and for switching to the plurality of delay units in the case the signal strength is below the predetermined threshold.

16. A device as claimed in claim 13, wherein the input audio signal includes a switching indicator, and wherein the switching unit is arranged for switching in dependence on the switching indicator.

17. A method of providing an output audio signal (L, R) based on an input audio signal, the input audio signal comprising a plurality of input subband signals (N), the method comprising:
delaying (501 . . . 504) at least part of the input subband signals to obtain a plurality of delayed subband signals, wherein at least one input subband signal is delayed more than a further input subband signal of higher frequency, and
deriving the output audio signal from a combination of the input audio signal and the plurality of delayed subband signals.

18. An apparatus (700) for supplying an output audio signal, the apparatus comprising:
an input unit (70) for obtaining an encoded audio signal,
a decoder (71) for decoding the encoded audio signal to obtain a decoded signal including a plurality of subband signals,
a device as claimed in claim 1 for obtaining the output audio signal based on the decoded signal, and
an output unit for supplying the output audio signal.
